(19) United States
(12) Patent Application Publication
(10) Pub. No.: US 2025/0378547 A1
(43) Pub. Date: Dec. 11, 2025

(54) SYSTEM FOR DETECTING FALLING OBJECT ON TABLE AND SERVER INCLUDED THEREIN

(71) Applicant: SAMSUNG DISPLAY CO., LTD., Yongin-si (KR)

(72) Inventors: Kyungsoo Lee, Yongin-si (KR); Joodong Yun, Yongin-si (KR); Jeongmin Choi, Yongin-si (KR)

(21) Appl. No.: 19/229,071

(22) Filed: Jun. 5, 2025

(30) Foreign Application Priority Data
Jun. 5, 2024 (KR) 10-2024-0073917

(51) Int. Cl. G06T 7/00; G06T 1/00; G06V 10/77; G06V 10/774; G06V 10/94; G06V 20/52

(52) U.S. Cl. CPC G06T 7/0008; G06T 1/0014; G06V 10/7753; G06V 10/95; G06V 20/52; G06T 2207/20081; G06T 2207/30148; G06V 10/7715; G06V 2201/06

(57) ABSTRACT

A system for detecting a falling object on a table includes a camera unit configured to obtain at least one image of a surface of the table, and a server configured to detect, from the at least one image, a first state in which an object is on the surface of a table or a second state in which no object is on the surface of the table, obtain information, when the first state is detected, on a first time during which the first state continues, detect that a falling object is on the surface of the table when the first time is more than a first reference time, and detect that no falling object is on the surface of the table when the first time is the first reference time or less.

### CROSS-REFERENCE TO RELATED APPLICATION

This US patent application is claims priority under 35 U.S.C. § 119 to Korean Patent Application No. 10-2024-0073917, filed on Jun. 5, 2024, in the Korean Intellectual Property Office, the disclosure of which is incorporated by reference in its entirety herein.

### 1. TECHNICAL FIELD

The present disclosure is directed to a system for detecting a falling object on a table and a server included in the system, and more particularly, to a system for detecting a falling object on a table.

### 2. DISCUSSION OF RELATED ART

Facilities for various manufacturing processes, such as display manufacturing processes and semiconductor manufacturing processes, have recently introduced automation technology. Parts, substrates, and other components are moved to a desired position by using pre-programmed robots, which carry out any necessary processes. Users manage and supervise manufacturing processes utilizing automated technologies through closed-circuit television (CCTV), monitoring systems, and similar tools.

Manufacturing processes may require a table for placing parts, substrates, and other components. If an object unrelated to a manufacturing process, such as a falling object, is placed on the table, the user may not be able to detect it using CCTV, monitoring systems, or similar tools. Various issues may occur in the manufacturing process due to the falling object. For example, falling objects can physically damage delicate equipment, such as wafer handlers, robotic arms, or precision tools used in the manufacturing process. This damage can result in downtime for repairs and costly replacement. Thus, systems for automatically detecting a falling object on a table are needed.

### SUMMARY

At least one embodiment is provided that includes a system for detecting a falling object on a table. The system automatically detects a falling object on a table by using a pre-installed camera and without any additional equipment. A server may be included in the system.

According to an embodiment, a system for detecting a falling object on a table includes a camera unit configured to obtain at least one image of a surface of the table, and a server configured to detect from the at least one image a first state in which an object is on the surface of the table or a second state in which no object is on the surface of the table, obtain information, when the first state is detected, on a first time during which the first state continues, detect that a falling object is on the surface of the table when the first time is more than a first reference time, and detect that no falling object is on the surface of the table when the first time is the first reference time or less, wherein the first reference time is a cycle time during which a robot device repeatedly performs certain operations.

In an embodiment, the first reference time may be a time during which the robot device performs a first operation of placing a substrate on the table, a second operation of waiting for a predetermined time, and a third operation of moving the substrate to a different position on the table.

In an embodiment, the server may be further configured to obtain information, when the second state is detected, on a second time during which the second state continues.

In an embodiment, the server may be further configured to detect that a process stop state in which the robot device is not in operation has occurred when the second time is greater than a second reference time.

In an embodiment, the server may be further configured to learn from a plurality of images of the surface of the table in advance by using an unsupervised learning algorithm.

In an embodiment, the plurality of images may be images of the table in a state in which no object is present on the table.

In an embodiment, the server may be further configured to detect a presence or an absence of the falling object based on a learning value output by an unsupervised learning algorithm.

In an embodiment, the at least one image may include a first image of a first area of the surface of the table, and a second image of a second area of the surface of the table.

In an embodiment, the camera unit may include a first camera configured to obtain the first image, and a second camera configured to obtain the second image.

In an embodiment, the server may be further configured to output information on a presence of the falling object to a user based on a result value generated in the detect of the server.

According to an embodiment, a server includes a memory, a processor configured to perform an operation according to an instruction stored in the memory, and a data transceiver configured to receive at least one image of a surface of a table from a camera unit, wherein the processor is further configured to detect, from the at least one image, a first state in which an object is on the surface of the table or a second state in which no object is on the surface of the table, obtain information, when the first state is detected, on a first time during which the first state continues, detect that a falling object is on the surface of the table when the first time is more than a first reference time, and detect that no falling object is on the surface of the table when the first time is the first reference time or less, wherein the first reference time is a cycle time during which a robot device repeatedly performs certain operations.

In an embodiment, the first reference time may be a time during which the robot device performs a first operation of placing a substrate on the table, a second operation of waiting for a predetermined time, and a third operation of moving the substrate to a different position on the table.

In an embodiment, the processor may be further configured to obtain information, when the second state is detected, on a second time, during which the second state continues.

In an embodiment, the processor may be further configured to detect that a process stop state in which the robot device is not in operation has occurred when the second time is more than a second reference time.

In an embodiment, the processor may be further configured to learn from a plurality of images of the surface of the table in advance by using an unsupervised learning algorithm.

In an embodiment, the plurality of images may be images of the table in a state in which no object is on the table.

In an embodiment, the processor may be further configured to detect a presence or an absence of the falling object based on a learning value output from an unsupervised learning algorithm.

In an embodiment, the at least one image may include a first image of a first area of the surface of the table, and a second image of a second area of the surface of the table.

In an embodiment, the data transceiver may be further configured to receive the first image from a first camera and receive the second image from a second camera.

In an embodiment, the processor may be further configured to generate information on presence of the falling object based on a result value generated in the detection operation of the processor.

In an embodiment, a system for monitoring manufacturing performed on a substrate disposed on a table is provided. The system includes a camera and a server. The camera is configured to capture sequential images of a surface of the table. The server is configured to: to receive the sequential images from the camera; detect a current state of the table based on the sequential images, wherein the current state is one of a first state indicating that an object is present on the surface of the table and a second state indicating that the object is not present on the surface of the table; determine a duration of the current state; determine the object to be one of a falling object or the substrate when the current state is the first state, based on the determined duration; and determine a state of a mover used in the manufacturing for moving the substrate when the current state is the second state, based on the determined duration. In an embodiment, the object is the falling object when the duration of the first state is more than a reference time and the object is the substrate when the duration of the first state is not more than the reference time. In an embodiment, the state of the mover is stopped when the duration of the second state is more than a reference time and moving when the duration of the second state is not more than the reference time.

### BRIEF DESCRIPTION OF THE DRAWINGS

The above and other aspects and features of certain embodiments of the disclosure will be more apparent from the following description taken in conjunction with the accompanying drawings, in which:

FIG. 1 is a conceptual diagram of a system for detecting a falling object on a table, according to an embodiment;

FIG. 2 is a schematic diagram illustrating an example of FIG. 1;

FIG. 3 is a conceptual diagram showing components included in a memory in FIG. 1;

FIG. 4 is a schematic flowchart of a method of detecting a falling object on a table, according to an embodiment;

FIG. 5 is a schematic diagram illustrating an example of a first image among images generated by a camera unit in FIG. 1;

FIG. 6 is a drawing illustrating an example of a chart including time information and a result value for the presence or absence of an object, which are obtained by a server in FIG. 1;

FIG. 7 is a drawing illustrating an example of a chart including time information and a result value for the presence or absence of an object, which are obtained by the server in FIG. 1; and

FIG. 8 is a schematic diagram illustrating an example of an algorithm implemented in the server in FIG. 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

As the disclosure allows for various changes and numerous embodiments, certain embodiments will be illustrated in the drawings and described in the written description. Effects and features of the disclosure, and methods for achieving them will be clarified with reference to embodiments described below in detail with reference to the drawings. However, the disclosure is not limited to the following embodiments and may be embodied in various forms.

Hereinafter, embodiments will be described with reference to the accompanying drawings, wherein like reference numerals refer to like elements throughout and a repeated description thereof is omitted.

As used herein, when various elements such as a layer, a region, a plate, and the like are disposed “on” another element, not only the elements may be disposed “directly on” the other element, but another element may be disposed therebetween. As used herein, when various elements such as a layer, a region, a plate, and the like are disposed “under” another element, not only the elements may be disposed “directly under” the other element, but another element may be disposed therebetween.

Spatially relative terms such as “below”, “lower”, “lower”, “lower”, “above”, “upper”, and the like may be terms used herein to easily describe the relationship of one element or feature. Terms used to describe space, direction, and the like in this specification are terms for describing the space and direction shown in the drawings, but may be understood as terms for describing various other directions or various viewpoints. As an example, in the case an apparatus or element shown in the drawing is turned over, the apparatus or element described “below” may be interpreted in a different orientation (e.g., rotated 90 degrees, in the opposite direction, and the like). As an example, in the case an apparatus or element shown in the drawing is turned over, the apparatus or element described “on” may be interpreted in a different orientation (e.g., rotated 90 degrees, in the opposite direction, and the like). Accordingly, “below” and “on” may include both upward and downward directions. In addition, an apparatus or element may be oriented differently from the drawings, and descriptions of a space or direction described herein may be interpreted in various ways.

The order of processes or the order of methods understood in the description of processing processes, manufacturing methods, and the like in this specification may be different from the described order. For example, two consecutively described processes or methods may be performed at the same time or substantially at the same time, or performed in an order opposite to the described order.

The x-axis, the y-axis and the z-axis are not limited to three axes of the rectangular coordinate system, and may be interpreted in a broader sense. For example, the x-axis, the y-axis, and the z-axis may be perpendicular to one another, or may represent different orientations that are not perpendicular to one another.

The terms “first,” “second,” “third” and the like may be used herein to describe specific elements. The terms “first,” “second,” “third” and the like may be used to distinguish one element from another.

When an element is referred to as being “connected to” or “coupled to” another element, it is understood that the element may be connected or coupled to the other element directly or indirectly.

Likewise, when one element is referred to as being “electrically” connected to another element, one element may be directly and electrically connected to the other element, or directly and electrically connected to the other element through a conductive element.

In addition, when an element is referred to as being “between” two elements, it may be understood that one element only is arranged between the two elements, or another element other than the one element is arranged between the two elements.

The terms used in this specification are used to describe specific embodiments and are not intended to limit the disclosure. As used herein, the singular forms “a,” “an” and “the” are intended to include the plural forms as well, unless the context clearly indicates otherwise.

For example, the term “and/or” includes any and all combinations of one or more of the associated listed items. For example, “A and/or B” means A or B, or A and B. Expressions such as “at least one” may be used to refer to one or more elements among a plurality of elements. For example, the expressions “at least one of a, b, and c” and “at least one selected from the group consisting of a, b, and c” are “a”, “b”, “c”, “a, b”, “b, c”, “a, c” or “a, b, c”.

For example, terms such as “substantially,” “approximately,” and similar terms are used as terms of approximation rather than terms of degree, and may be terms to describe inherent variations in measured or calculated values that would be recognized by a person of ordinary skill in the art. For example, use of terms such as “can,” “may,” and the like may be used to mean “one or more embodiments disclosed herein”.

Electronic or electrical devices and/or any other related devices or components (e.g., some of the various modules) according to embodiments of the disclosure described herein may be configured with any suitable hardware, firmware (e.g., for example, it may be implemented using a combination of application-specific integrated circuits), software, firmware, and hardware. For example, the various components of these devices may be formed on one integrated circuit (IC) chip or on separate IC chips. Moreover, the various components of these devices may be formed on a flexible printed circuit film, a tape carrier package (TCP), a printed circuit board (PCB), or on a single substrate. Additionally, the various components of these devices may be processes or threads, run on one or more processors, execute computer program instructions on one or more computing devices, and interact with other system components to perform various functions described herein.

Computer program instructions are stored in memory that can be implemented in a computing device using standard memory devices, such as random—access memory (RAM). Computer program instructions may also be stored on other non-transitory computer-readable media, such as, for example, a CD-ROM, flash drive, and the like. Additionally, one of ordinary skilled in the art will recognize that the functionality of various computing devices may be combined or integrated into a single computing device, or that the functionality of a particular computing device may be dispersed across one or more other computing devices without departing from the spirit and scope of the example embodiments of the disclosure.

Hereinafter, a system for detecting a falling object on a table according to an embodiment is described in detail.

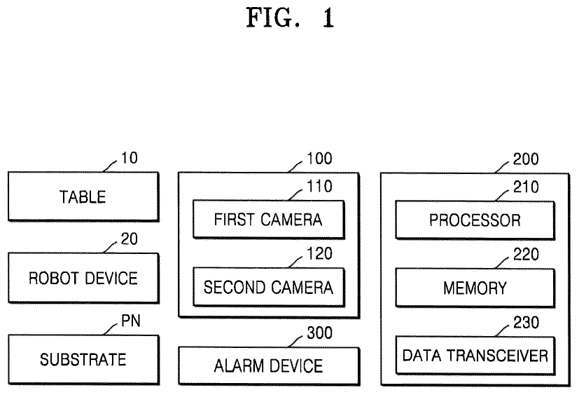

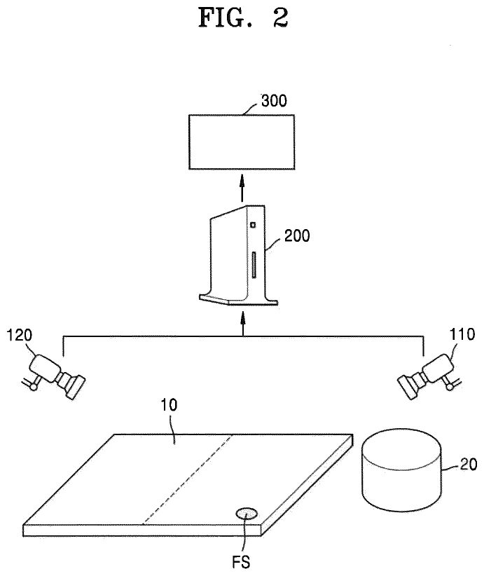

FIG. 1 is a conceptual diagram of a system for detecting a falling object on a table, according to an embodiment, and FIG. 2 is a schematic diagram illustrating an example of FIG. 1.

As shown in FIGS. 1 and 2, a system (hereinafter, a “detection system”) for detecting a falling object on a table, according to an embodiment, includes a table 10 (e.g., a platform, a work surface, a plate, a pallet, etc.), a camera unit 100, and a server 200. In addition, the detection system may further include a robot device 20 and an alarm device 300. In some cases, a panel may also be included as a component of the detection system.

In an embodiment, the table 10 is used in a process of manufacturing a display panel of a display device or other structure, and may be a component on which a substrate PN or another element is placed. The substrate PN to be moved by the robot device 20, may be placed on the table 10, or an empty space may be created on the table 10 after the substrate PN is removed by the robot device 20. The table 10 or the upper surface of the table 10 may include a first area and a second area. The first area and the second area may be adjacent to each other.

The substrate PN may be a component used in a process of manufacturing the display panel or another structure, and may refer to any substrate used in the process of manufacturing the display panel, such as a buffer substrate or a semiconductor substrate. Alternatively, the substrate PN may refer to the display panel itself that has been manufactured to a certain extent. The substrate PN may be moved by a user or by the robot device 20 to be described below. The substrate PN may be moved from one table to another table. The substrate PN may be moved to a different position on the table 10 by the robot device 20.

The camera unit 100 may refer to a camera device for generating an image or video. Hereinafter, the image referred to in the present specification may refer to a still image or at least one frame image constituting a video. Therefore, the image referred to in the present specification may refer to image data included in a video.

The camera unit 100 in the present specification may include an existing closed-circuit television (CCTV) camera installed around a manufacturing facility. A method of detecting a falling object on a table, according to an embodiment, uses an image generated by a CCTV camera to detect a falling object FS on the table 10, thereby having the effect of detecting the falling object FS on the table 10 at a minimum cost without having to install an additional device.

The server 200 may include a processor 210, a memory 220, and a data transceiver 230. In addition, the server 200 may receive a user input from a user and perform a preset command or operation task based on the received user input.

The processor 210 may control other components by executing instructions stored in the memory 220. The processor 210 may execute instructions stored in the memory 220.

The processor 210 is a component that may perform operations and control other devices. The processor may refer to a microprocessor, a central processing unit, an application processor, a graphics processing unit, etc.

The processor 210 may process signals, data, information, etc. input or output through the components described above or operate an application program stored in the memory 220, and thus may process appropriate information or provide functions to the user.

The memory 220 stores data that supports various functions of the server 200. The memory 220 may store a plurality of application programs (or applications) running on the server 200, data for the operation of the server 200, and instructions.

The memory 220 may include at least one type of storage medium among a flash memory type, hard disk type, solid state disk (SSD) type, silicon disk drive (SDD) type, multimedia card micro type, or card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The data transceiver 230 may perform a wired communication function and/or a wireless communication function for transmitting and receiving data between components. The data transceiver 230 may have a data transmission/reception interface for performing a wired communication function and/or a wireless communication function.

For example, the data transceiver 230 may receive at least one image from the camera unit 100. The data transceiver 230 may receive a first image from a first camera 110 and a second image from a second camera 120. The data transceiver 230 may transmit an operation value calculated by the processor 210 or a command to the robot device 20, the alarm device 300, etc.

The server 200 may receive at least one image of the upper surface of the table 10 from the camera unit 100. The at least one image may include a first image of the first area of the upper surface of the table 10 and a second image of the second area of the upper surface of the table 10.

The camera unit 100 described above may generate at least one image of the upper surface of the table 10. For example, the camera unit 100 may include the first camera 110 that acquires the first image and the second camera 120 that acquires the second image. Alternatively, the camera unit 100 may additionally include other cameras in addition to the first camera 110 and the second camera 120.

The first camera 110 may be placed around the first area, and the second camera 120 may be placed around the second area. The first camera 110 may be placed to face the first area, and the second camera 120 may be placed to face the second area.

The robot device 20 may include a head that selects a target and places the selected target on the table 10 at a certain location, or a manipulator. The robot device 20 may move the substrate PN from a first position to a second position. For example, the robot device 20 may move the substrate PN placed on the table 10 to another position. Alternatively, the robot device 20 may move the substrate PN located at another position onto the table 10. In this case, the robot device 20 may move the substrate PN by using a manipulator or may move the substrate PN by using an adsorption means.

The alarm device 300 may be a device that transmits an alarm to the user through hearing, vision, etc. when receiving an alarm command from the server 200. The alarm device 300 may include various alarm means known in the art. For example, the alarm device 300 may be a display device and may transmit a warning to the user through a visual message.

The server 200 may receive at least one image of the upper surface of the table 10 from the camera unit 100. The server 200 may detect a first state in which there is an object on the upper surface of the table 10 or a second state in which there is no object on the upper surface of the table 10, based on at least one image received from the camera unit 100.

As described above, the server 200 may receive the first image from the first camera 110 and the second image from the second camera 120. For example, the server 200 may detect the first area of the upper surface of the table 10 in the first image and detect whether the first area is in the first state or the second state. For example, the server 200 may detect the second area of the upper surface of the table in the second image and detect whether the second area is in the first state or the second state.

When the first state is detected, the server 200 may obtain information on a first time during which the first state continues. The server 200 may detect a first state in which there is a falling object FS on the upper surface of the table 10 when the first time is greater than a first reference time, and may detect a second state in which there is no falling object FS on the upper surface of the table 10 when the first time is the first reference time or less. For example, if images are periodically captured during a period of time greater than the first reference time, and the falling object FS is present in all of the images, it could be concluded that an object is present that will cause a problem. However, in this example, if the falling object FS is not present in one or more of the images, it may be concluded that a problem should not occur due to the presence of an object.

The first reference time may be a cycle time during which the robot device 20 repeatedly performs certain operations. For example, the first reference time may be a time during which the robot device 20 performs a first operation of placing the substrate PN on the table 10, a second operation of waiting for a predetermined time, and a third operation of moving the substrate PN to a different position on the table 10.

For example, the server 200 may detect a state on the table 10 as the first state or the second state. When the robot device 20 performs a normal operation and there is no falling object FS on the table 10, the state on the table 10 may change from the first state to the second state or may change from the second state to the first state. In addition, the state of the table 10 may change according to a cycle time (e.g., the first reference time) during which the robot device 20 repeatedly performs certain operations.

However, when the time at which the state of the table 10 changes is different from the first reference time, it may be assumed that the falling object FS has fallen on the table 10 or that a problem has occurred in the operation of the robot device 20. In this way, the detection system according to an embodiment may detect the falling object FS on the table 10 by using the periodicity of the robot device 20 performing repetitive operations with a certain cycle.

When the second state is detected, the server 200 may obtain information on a second time during which the second state continues. The server 200 may detect that a process stop state in which the robot device 20 is not in operation has occurred when the second time is more than a second reference time. For example, the process stop state may indicate that the robot device 20 or another mover has stopped moving the substrate PN. If the second time is not more than a second reference time, it may indicate a process running state indicating the robot 20 or another mover is presently moving the substrate PN during a manufacturing process performed on the substrate PN. The second reference time may be the same as the first reference time, but is not limited thereto.

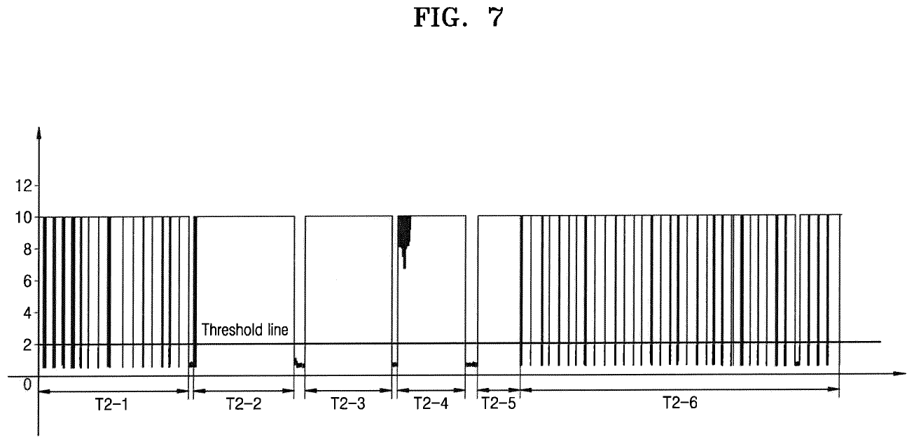

The server 200 may learn from a plurality of images of the upper surface of the table 10 in advance by using an unsupervised learning algorithm. The plurality of images may be images of the table 10 in a state where there is no object on the table 10. The server 200 may easily detect the case where there is an object on the table 10 by learning from the images in a state where there is no object on the table 10. For example, the unsupervised learning algorithm may be trained on these images to detect whether a failing object is present in a new image. For example, the unsupervised learning algorithm may be a FastFlow algorithm, and a detailed description of the FastFlow algorithm is described with reference to FIG. 7 below.

The server 200 may detect the presence or absence of an object on the table 10 based on a learning value of the unsupervised learning algorithm. For example, features of the new image may be input to the unsupervised learning algorithm to generate the learning value. The server 200 may obtain information on the presence of the falling object FS on the table 10 based on the time that the state on the table 10 is maintained due to the presence of an object. For example, if the learning value has a value in a range indicative of the object for a new image, and the learning value continues to have a value in the same range for all subsequent new images over a period of time greater than the first reference time, it might be concluded that a falling object is present. The server 200 may output information on the presence of the falling object FS to the user through the alarm device 300, etc.

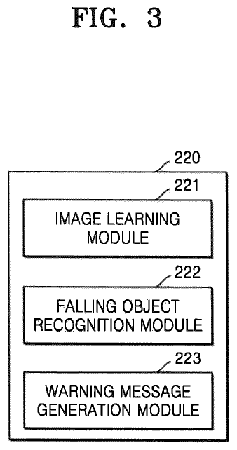

FIG. 3 is a conceptual diagram showing components included in the memory 220 in FIG. 1.

As shown in FIG. 3, the memory 220 may include an image learning module, a falling object recognition module, and a warning message generation module.

The image learning module 221 may learn from input images (e.g., training images) by using the unsupervised learning algorithm described above. The image learning module 221 may store instructions required for the unsupervised learning algorithm described above and store results from learning from the input images.

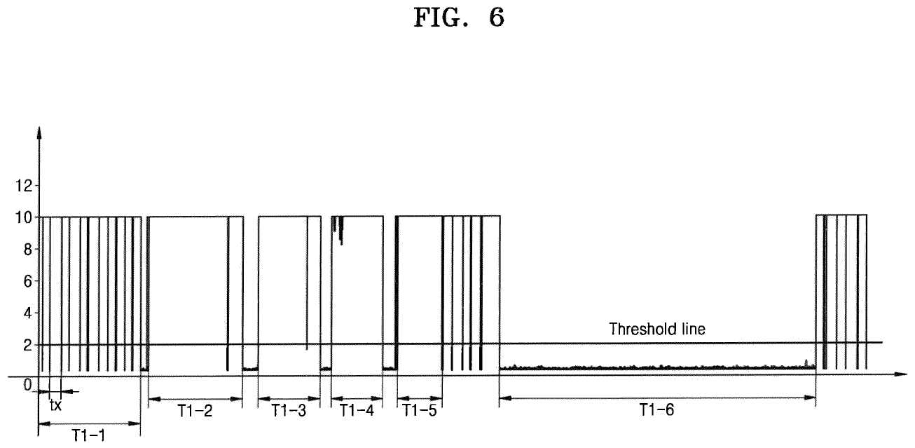

The falling object recognition module 222 may obtain information on whether there is a falling object FS on the table 10 based on the results and information on an operation execution cycle of the robot device 20. The operation execution cycle may be the period of time in which the robot device 20 completes one full sequence of its assigned tasks. The falling object recognition module 222 may (1) obtain information on whether there is an object on the table 10, (2) obtain the duration of the state in which there is an object on the table 10, and (3) finally detect whether the object on the table 10 is a falling object FS based on the obtained duration, as shown in FIGS. 6 and 7 described below.

The warning message generation module 223 may load a pre-input warning message and transmit the loaded warning message to the alarm device 300 to output the loaded warning message to the user in various ways, such as sense of hearing and sense of sight. The warning message generation module 223 may receive a result value from the falling object recognition module 222 and transmit a warning message to the alarm device 300 based on the received result value.

Hereinafter, based on the above descriptions, a detailed description of a method of detecting a falling object on a table, according to an embodiment, will be described in detail.

For reference, a description, which is the same as the description of the detection system given above, in the description of the method (hereinafter, referred to as the detection method) of detecting a falling object on a table, according to an embodiment, may be omitted. Additionally, the subject performing the detection method may be the server 200 described above or a processor included in the server 200.

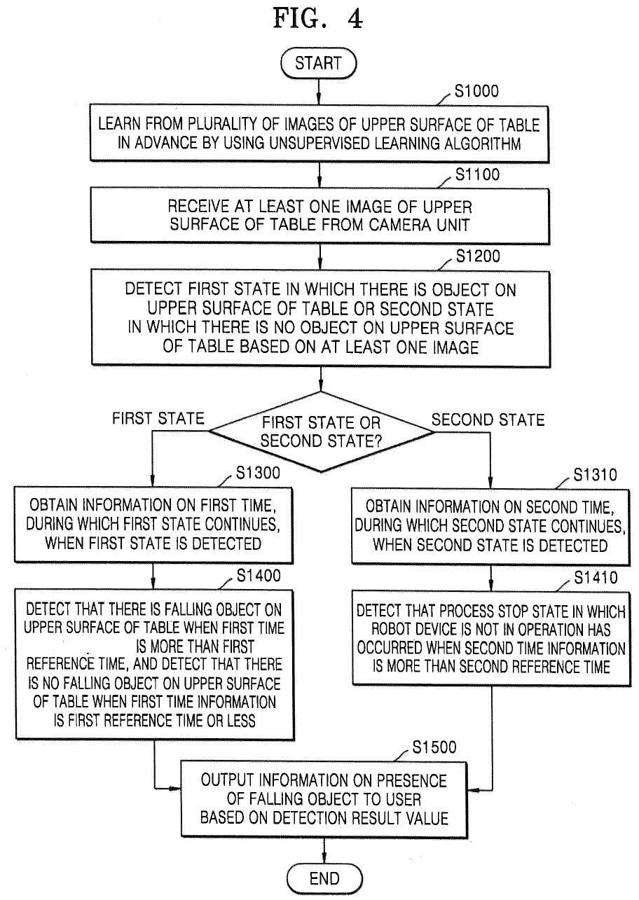

FIG. 4 is a schematic flowchart of a method of detecting a falling object on a table, according to an embodiment.

As shown in FIG. 4, the detection method according to an embodiment includes operation S1100 of receiving at least one image of the upper surface of the table 10 from the camera unit 100.

The at least one image may include a first image of a first area of the upper surface (or any surface) of the table 10 and a second image of a second area of the upper surface of the table 10. The camera unit 100 may include a first camera 110 for obtaining the first image and a second camera 120 for obtaining the second image.

For example, the operation S1100 of receiving at least one image from the camera unit 100 may include receiving the first image from the first camera 110 and receiving the second image from the second camera 120.

The detection method according to an embodiment may further include an operation S1200 of detecting a first state in which there is an object on the upper surface of the table 10 or a second state in which there is no object on the upper surface of the table 10 based on the at least one image received from the camera unit 100.

For example, the operation S1200 of detecting the first state or the second state may include detecting the first area of the upper surface of the table 10 in the first image and detecting whether the first area is in the first state or the second state. For example, the operation S1200 of detecting the first state or the second state may include detecting the second area of the upper surface of the table 10 in the second image and detecting whether the second area is in the first state or the second state.

For example, the operation S1200 of detecting the first state or the second state may include detecting a state of the table 10 as the first state or the second state. When the robot device 20 performs a normal operation and there is no falling object FS on the table 10, the state of the table 10 may change from the first state to the second state or may change from the second state to the first state. In addition, the state of the table 10 may change according to a cycle time (e.g., the first reference time) during which the robot device 20 repeatedly performs certain operations.

The detection method according to an embodiment may further include an operation S1300 of obtaining information on a first time, during which the first state continues, when the first state is detected.

The detection method according to an embodiment may further include an operation S1400 of detecting that there is a falling object FS on the upper surface of the table 10 when the first time is more than a first reference time, and detecting that there is no falling object FS on the upper surface of the table 10 when the first time is the first reference time or less.

The first reference time may be a cycle time during which the robot device 20 repeatedly performs certain operations. In an embodiment, the first reference time is a time during which the robot device 20 performs a first operation of placing the substrate PN on the table 10, a second operation of waiting for a predetermined time, and a third operation of moving the substrate PN to a different position on the table 10.

For example, when the falling object FS does not fall on the table 10, the first state and the second state may be repeatedly changed at the cycle of the first reference time. However, when the falling object FS falls on the table 10, even though the robot device 20 moves the substrate PN to a different position on the table 10, the server 200 may detect that there is an object on the table 10. That is, when the falling object FS falls on the table 10, even though the robot device 20 moves the substrate PN to a different position on the table 10, the server 200 detects the state on the table 10 as the first state.

Therefore, when there is a falling object FS on the table 10, the server 200 detects the state on the table 10 as the first state regardless of the position of the substrate PN. The server 200 may detect or recognize the presence or absence of the falling object FS based on information on the duration of the first state.

The detection method according to an embodiment may further include an operation S1310 of obtaining information on a second time, during which the second state continues, when the second state is detected. The detection method may further include an operation S1410 of detecting that a process stop state in which the robot device 20 is not in operation has occurred when the second time is more than a second reference time. The second reference time may be the same the first reference time, but is not limited thereto.

For example, when the robot device 20 performs a repetitive operation according to the first reference time or the second reference time, the state of the table changes between the first state and the second state at regular intervals. However, in the case of a special situation, such as a shortage of the substrate PN or a stop of the robot device 20, the second state may be maintained for a longer period of time than the operating cycle of the robot device 20. The server 200 may define such a case as an abnormal state and output a preset warning message indicating the abnormal case to the user through the alarm device 300 described above. The shortage of the substrate PN may indicate that the robot device 20 has reached an end or advanced beyond an end of the substrate PN.

In the detection method according to an embodiment, the operation S1200 of detecting the first state or the second state may include detecting the presence or absence of the falling object FS based on a learning value output by the unsupervised learning algorithm.

The unsupervised learning algorithm may learn from a plurality of images (e.g., training images) of the upper surface of the table 10 in advance. To this end, the detection method according to an embodiment may further include operation S1000 of learning from a plurality of images of the upper surface of the table 10 in advance by using the unsupervised learning algorithm. The server 200 may have pre-stored learning values derived by the unsupervised learning algorithm. The plurality of images may be images of the table 10 in a state where there is no object on the table 10. The server (200) may easily detect the case where there is an object on the table 10 by learning from images in a state where there is no object on the table 10. For example, the unsupervised learning algorithm may include a FastFlow algorithm, and a detailed description of the FastFlow algorithm is described with reference to FIG. 7 below.

Specifically, a method of detecting a falling object on a table, according to an embodiment, may include receiving at least one image of the upper surface of a table from a camera unit. Based on the image, the method detects either a first state, where there is an object on the upper surface of the table, or a second state, where there is no object on the upper surface of the table. When the first state is detected, the system obtains information on a first time, representing how long the first state continues. If the first time exceeds a first reference time, the system detects the presence of a falling object on the table. If the first time is equal to or less than the first reference time, it detects that there is no falling object on the table. The first reference time may be a cycle time during which a robot device repeatedly performs certain operations.

In an embodiment, the first reference time is a time during which the robot device performs a first operation of placing a substrate on the table, a second operation of waiting for a predetermined time, and a third operation of moving the substrate to a different position on the table.

In an embodiment, the detection method may further include obtaining information on a second time, during which the second state continues, when the second state is detected.

In an embodiment, the detection method may further include detecting that a process stop state in which the robot device is not in operation has occurred when the second time is more than a first reference time.

In an embodiment, the detection method may further include learning from a plurality of images of the upper surface of the table in advance by using an unsupervised learning algorithm.

In an embodiment, the plurality of images may be images of the table in a state where there is no object on the table.

In an embodiment, the detecting of the first state or the second state may include detecting the presence or absence of the falling object based on a learning value output by the unsupervised learning algorithm. The detecting of the presence or absence of the falling object may set a result value. For example, the result value could have a first value to indicate the object has been present for more than a reference time, a second value different from the first value to indicate the object was present but not for more than the reference time, a third value different from the first and second values to indicate the object has not been present for more than the reference time, or a fourth value different from the first through third values to indicate the object has not been present but this state has not been maintained more than the first reference time.

In an embodiment, the at least one image may include a first image of a first area of the upper surface of the table and a second image of a second area of the upper surface of the table. In an embodiment, the first area does not overlap with the second area.

In an embodiment, the camera unit may include a first camera for obtaining the first image and a second camera for obtaining the second image.

In an embodiment, the detection method may further include outputting information on the presence of the falling object to the user based on a result value generated in the detecting.

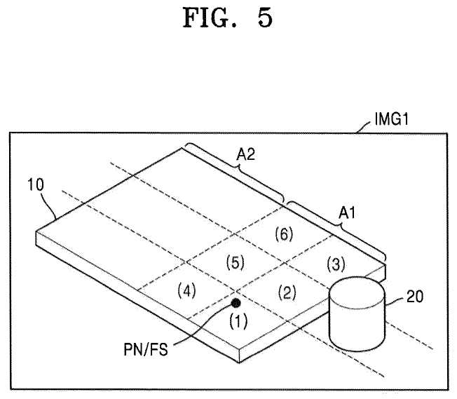

FIG. 5 is a schematic diagram illustrating an example of a first image among the images generated by the camera unit in FIG. 1.

As shown in FIG. 5, the table 10 or a surface (e.g., an upper surface) of the table 10 may be divided into a first area A1 and a second area A2. FIG. 5 shows a first image IMG1 obtained by the first camera 110, and the server 200 may detect whether there is an object on the table 10 with respect to the first area A1.

For example, the server 200 may divide the first area A1 into a plurality of sub-areas. The server 200 may detect or recognize which area among the plurality of sub-areas the object is located in by using an unsupervised learning algorithm. The object may be a substrate PN or a falling object FS.

For example, when the server 200 detects that there is a falling object FS on the table 10, the server 200 may detect, recognize, or derive which area among the plurality of sub-areas the falling object FS is located in.

For example, the detection method described above may include detecting the position of the falling object FS or generating position information, based on the plurality of sub-areas, when the first time is more than the first reference time and it is detected that there is a falling object FS on the upper surface of the table 10. In FIG. 5, six sub-areas are illustrated, but the inventive concept is not limited to any particular number of sub-areas. For example, the position information could include a number that identifies the number of the sub-area in which the falling object FS is present.

FIG. 6 is a drawing illustrating an example of a chart including time information and a result value for the presence or absence of an object, which are obtained by the server in FIG. 1.

The chart shown in FIG. 6 represents time on the x-axis and the output value of the server 200 on the y-axis. For example, the unit of the x-axis is minutes (min). For convenience of description, only the chart for the first image is described, but the descriptions given with reference to FIG. 6 may also apply to the second image, etc.

For example, the output value of the y-axis may have a value of about 0 to about 10. The server 200 may conclude the state of the table 10 to be the first state or the second state according to the output value of the y-axis.

For example, the server 200 may output an output value of 10 when an object is detected in the first image. For example, the server 200 may output an output value of 0 when an object is not detected in the first image.

Therefore, in FIG. 6, when the y-axis value is 10, it indicates that the server 200 has detected that there is an object on the table 10 (a first state), and in FIG. 6, when the y-axis value is 0, it indicates that the server 200 has detected that there is no object on the table 10 (a second state).

For example, the 1st-1 time T1-1 may be a time during which there is no falling object FS on the table 10. The 1st-1 time T1-1 may be a time during which there is an object on the table 10, but the object on the table 10 is a substrate PN and not a falling object FS. Specifically, the period in which the state of the table 10 changes to the first state or the second state during the 1st-1 time T1-1 may be equal to a first reference time tx, which is the operating cycle of the robot device 20, or may be less than the first reference time tx. Therefore, the 1st-1 time T1-1 may be a time during which the falling object FS does not fall on the table 10, and may be a time during which the robot device 20 normally operates.

For example, the 1st-2 time T1-2 may be a time during which there is a falling object FS on the table 10. It is confirmed that the 1st-2 time T1-2 is much longer than the first reference time tx, which is the operating cycle of the robot device 20. Therefore, the 1st-2 time T1-2 may be a time during which a falling object FS falls or is present on the table 10, and the server 200 may detect or recognize the state of the table 10 as a state in which the falling object FS falls.

For example, the 1st-3 time T1-3 may be a time during which there is a falling object FS on the table 10. It is confirmed that the 1st-3 time T1-3 is much longer than the first reference time tx, which is the operating cycle of the robot device 20. Therefore, the 1st-3 time T1-3 may be a time during which a falling object FS falls or is present on the table 10, and the server 200 may detect or recognize the state of the table 10 as a state in which the falling object FS falls.

For example, the 1st-4 time T1-4 may be a time during which there is a falling object FS on the table 10. It is confirmed that the 1st-4 time T1-4 is much longer than the first reference time tx, which is the operating cycle of the robot device 20. Therefore, the 1st-4 time T1-4 may be a time during which a falling object FS falls or is present on the table 10, and the server 200 may detect or recognize the state of the table 10 as a state in which the falling object FS falls.

For example, the 1st-5 time T1-5 may be a time during which there is a falling object FS on the table 10. It is confirmed that the 1st-5 time T1-5 is much longer than the first reference time tx, which is the operating cycle of the robot device 20. Therefore, the 1st-5 time T1-5 may be a time during which a falling object FS falls or is present on the table 10, and the server 200 may detect or recognize the state of the table 10 as a state in which the falling object FS falls.

For example, the 1st-6 time T1-6 may be a time during which there is no object on the table 10. It is confirmed that the 1st-6 time T1-6 is much longer than the first reference time tx, which is the operating cycle of the robot device 20. Therefore, the 1 st-6 time T1-6 may be a time during which a process stop state, in which the substrate PN is insufficient or the robot device 20 is not in operation, continues.

As shown in FIG. 6, a threshold line may be disclosed. The server 200 may detect or recognizes whether there is an object on the table 10 based on the y-axis value, and the y-axis value obtained may vary depending on the size of the object, error, etc. To derive a stable result from such a change, the server 200 may detect or recognize the first state or the second state based on the threshold line.

For example, when the y-axis value indicated by the threshold line is 2, the server 200 may detect or recognize that there is no object on the table 10 (the second state) when the y-axis value is 2 or less, and the server 200 may detect or recognize that there is an object on the table 10 (the first state) when the y-axis value is more than 2. The threshold line may be understood as a threshold value on the y-axis.

The threshold value may be a value input by the user.

FIG. 7 is a drawing illustrating an example of a chart including time information and a result value for the presence or absence of an object, which are obtained by the server in FIG. 1.

The chart shown in FIG. 7 represents time on the x-axis and the output value of the server 200 on the y-axis. For example, the unit of the x-axis is minutes (min). For convenience of description, only the chart for the first image is described, but the descriptions given with reference to FIG. 7 may also apply to the second image, etc.

For example, the output value of the y-axis may have a value of about 0 to about 10. The server 200 may conclude the state of the table 10 to be the first state or the second state according to the output value of the y-axis.

For example, the server 200 may output an output value of 10 when an object is detected in the first image. For example, the server 200 may output an output value of 0 when an object is not detected in the first image.

Therefore, in FIG. 7, when the y-axis value is 10, it indicates that the server 200 has detected that there is an object on the table 10 (a first state), and in FIG. 7, when the y-axis value is 0, it indicates that the server 200 has detected that there is no object on the table 10 (a second state).

The 2nd-1 time T2-1 may be a time during which there is no falling object FS on the table 10. For example, the 2nd-1 time T2-1 may be a time during which there is an object on the table 10, but the object on the table 10 is a substrate PN and not a falling object FS. Specifically, the period in which the state of the table 10 changes to the first state or the second state during the 2nd-1 time T2-1 may be equal to the first reference time tx in FIG. 6, which is the operating cycle of the robot device 20, or may be less than the first reference time tx. Therefore, the 2nd-1 time T2-1 may be a time during which the falling object FS does not fall on the table 10, and may be a time during which the robot device 20 normally operates.

For example, the 2nd-2 time T2-2 may be a time during which there is a falling object FS on the table 10. It is confirmed that the 2nd-2 time T2-2 is much longer than the first reference time tx, which is the operating cycle of the robot device 20. Therefore, the 2nd-2 time T2-2 may be a time during which a falling object FS falls or is present on the table 10, and the server 200 may detect or recognize the state of the table 10 as a state in which the falling object FS falls.

For example, the 2nd-3 time T2-3 may be a time during which there is a falling object FS on the table 10. It is confirmed that the 2nd-3 time T2-3 is much longer than the first reference time tx, which is the operating cycle of the robot device 20. Therefore, the 2nd-3 time T2-3 may be a time during which a falling object FS falls or is present on the table 10, and the server 200 may detect or recognize the state of the table 10 as a state in which the falling object FS falls.

For example, the 2nd-4 time T2-4 may be a time during which there is a falling object FS on the table 10. It is confirmed that the 2nd-4 time T2-4 is much longer than the first reference time tx, which is the operating cycle of the robot device 20. Therefore, the 2nd-4 time T2-4 may be a time during in which a falling object FS falls or is present on the table 10, and the server 200 may detect or recognize the state of the table 10 as a state in which the falling object FS falls.

For example, the 2nd-5 time T2-5 may be a time during which there is a falling object FS on the table 10. It is confirmed that the 2nd-5 time T2-5 is much longer than the first reference time tx, which is the operating cycle of the robot device 20. Therefore, the 2nd-5 time T2-5 may be a time during which a falling object FS falls or is present on the table 10, and the server 200 may detect or recognize the state of the table 10 as a state in which the falling object FS falls.

The 2nd-6 time T2-6 may be a time during which there is no falling object FS on the table 10. For example, the 2nd-6 time T2-6 may be a time during which there is an object on the table 10, but the object on the table 10 is a substrate (PN) and not a falling object FS. Specifically, the period in which the state on the table 10 changes to the first state or the second state during the 2nd-6 time T2-6 may be equal to the first reference time tx, which is the operating cycle of the robot device 20, or may be less than the first reference time tx. Therefore, the 2nd-6 time T2-6 may be a time during which the falling object FS does not fall on the table 10, and may be a time during which the robot device 20 normally operates.

For example, when the y-axis value indicated by the threshold line is 2, the server 200 may detect or recognize that there is no object on the table 10 (the second state) when the y-axis value is 2 or less, and the server 200 may detect or recognize that there is an object on the table 10 (the first state) when the y-axis value is more than 2. The threshold line may be understood as a threshold value on the y-axis. The threshold value may be a value input by the user.

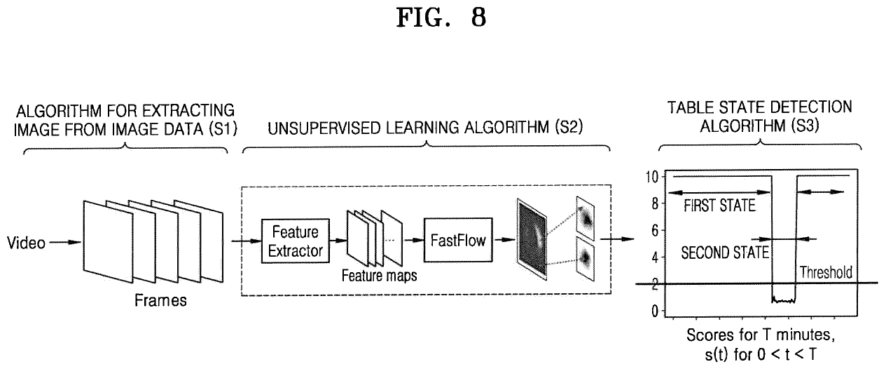

FIG. 8 is a schematic diagram illustrating an example of an algorithm implemented in the server in FIG. 1 according to an embodiment.

For reference, the description of the algorithm given below with reference to FIG. 8 is the same as the description of the method of detecting a falling object on the table 10, according to the embodiment, or the description of the operation process performed in the server 200 of FIG. 1.

As shown in FIG. 8, the example of the algorithm implemented in the server 200 of FIG. 1 may be largely defined in three steps. The camera unit 100 used in the present specification may be a pre-installed CCTV camera. In this case, the server 200 may extract a frame image included in image data received from the CCTV camera, and at this time, the server 200 may use an algorithm S1 for extracting an image from the image data. Although it is possible to detect a falling object FS based on the image data, it is preferable to use extracted images (the at least one image, the first image, the second image, etc. described above) to prevent excessive system load. The algorithm S1 for extracting an image from image data may extract a random image or extract an image according to a certain cycle from the image data. To this end, a conventionally known algorithm may be used as the algorithm S1 for extracting an image from the image data.

As shown in FIG. 8, the extracted image may be input to an unsupervised learning algorithm S2. The description of the unsupervised learning algorithm S2 of FIG. 8 is as follows.

An example of the unsupervised learning algorithm S2 may include a FastFlow algorithm. The unsupervised learning algorithm S2 may be a two-dimensional (2D) normalized Flow model for anomaly detection and position confirmation using the FastFlow algorithm.

The unsupervised learning algorithm S2 may refer to an algorithm for identifying an abnormal image and finding an abnormal area for anomaly detection and position confirmation in the field of computer vision. The unsupervised learning algorithm S2 may have the characteristic of learning only from normal samples during a training process, and may be an algorithm that identifies abnormal data and confirms the position thereof during testing by learning from only normal samples.

For example, the unsupervised learning algorithm S2 may learn by converting the distribution of normal image features into a standard normal distribution by using a fully convolutional network.

For example, unlike the existing one-dimensional (1D) normalized Flow model, the unsupervised learning algorithm S2, which is a 2D normalized Flow model, may maintain 2D spatial information of an input image feature map by using a 2D convolution operation.

For example, the unsupervised learning algorithm S2 may maintain a spatial position relationship of the input image feature map by using a fully convolutional network as a subnet. The FastFlow algorithm included in the unsupervised learning algorithm S2 may include a structure in which 3×3 convolutions and 1×1 convolutions are alternately stacked, and may implement a small-sized model by using the alternating structure.

For example, the unsupervised learning algorithm S2 may output anomaly detection and position confirmation results for the entire input image at once by using an end-to-end inference method. The unsupervised learning algorithm S2 may generate a result value by combining the FastFlow algorithm with various feature extractors, such as ResNet and Vision Transformer.

For example, the unsupervised learning algorithm S2 may learn to convert the distribution of normal image feature maps into a standard normal distribution during a training process, and may perform anomaly detection and position confirmation by using a probability value of each position as an anomaly score during inference. Therefore, the unsupervised learning algorithm S2 used in the disclosure may have an increased 2D spatial modeling capability compared to the existing 1D normalization flow, and faster inference speed due to the end-to-end structure, and may have higher accuracy and efficiency than general unsupervised learning algorithms.

As shown in FIG. 8, based on a result value (for example, the chart of FIG. 6 or 7) derived by the unsupervised learning algorithm S2, the server 200 may perform a table state detection algorithm S3. The table state detection algorithm S3 may be an algorithm for the server 200 to detect or recognize whether the state of the table 10 is the first state or the second state, as described above with reference to FIGS. 1 to 7. For example, the server 200 may obtain information on a time during which the first state or the second state continues, and may compare the obtained time information with the first reference time, which is the operating cycle of the robot device 20. The server 200 may detect or recognize whether an object on the table 10 is a falling object FS based on the obtained time information and the first reference time.

In an embodiment, a system for monitoring manufacturing performed on a substrate (e.g., PN) disposed on a table is provided. The system includes a camera (e.g., 110) and a server (e.g., 200). The camera is configured to capture sequential images of a surface of the table (e.g., 10). The server is configured to: to receive the sequential images from the camera; detect a current state of the table based on the sequential images, wherein the current state is one of a first state indicating that an object is present on the surface of the table and a second state indicating that the object is not present on the surface of the table; determine a duration of the current state; determine the object to be one of a falling object FS or the substrate PN when the current state is the first state, based on the determined duration; and determine a state of a mover (e.g., a robot 20) used in the manufacturing for moving the substrate when the current state is the second state, based on the determined duration. In an embodiment, the object is the falling object when the duration of the first state is more than a first reference time and the object is the substrate when the duration of the first state is not more than the reference time. In an embodiment, the state of the mover is stopped when the duration of the second state is more than a reference time and moving when the duration of the second state is not more than a second reference time. The first and second reference times may be the same as one another or different from one another as needed.

According to embodiments as described above, a system for detecting a falling object on a table is provided where the system automatically detects a falling object on a table without additional equipment by using a pre-installed camera. A server may be included in the system. However, the scope of the disclosure is not limited by this effect.

While certain embodiments have been described, it will be readily apparent to those of ordinary skill in the art that various modifications may be made without departing from the spirit and scope of the disclosure. Unless otherwise stated, the description of features or aspects within the embodiments should generally be considered to be applicable to other similar features or aspects of other embodiments. Accordingly, as it is apparent to those of ordinary skill in the art, features or components described in association with specific embodiments may be combined with features or components described in association with other embodiments. Therefore, the foregoing should not be construed as being limited to the specific embodiments set forth herein, but should be understood to be intended to be combined with or applied to other embodiments.

What is claimed is:

1. A system for detecting a falling object on a table, the system comprising:
a camera unit configured to obtain at least one image of a surface of the table; and
a server configured to detect from the at least one image a first state in which an object is on the surface of the table or a second state in which no object is on the surface of the table, obtain information, when the first state is detected, on a first time during which the first state continues, detect that a falling object is on the surface of the table when the first time is more than a first reference time, and detect that no falling object is on the surface of the table when the first time is the first reference time or less,
wherein the first reference time is a cycle time during which a robot device repeatedly performs certain operations.

2. The system of claim 1, wherein the first reference time is a time during which the robot device performs a first operation of placing a substrate on the table, a second operation of waiting for a predetermined time, and a third operation of moving the substrate to a different position on the table.

3. The system of claim 1, wherein the server is further configured to obtain information, when the second state is detected, on a second time during which the second state continues.

4. The system of claim 3, wherein the server is further configured to detect that a process stop state in which the robot device is not in operation has occurred when the second time is greater than a second reference time.

5. The system of claim 1, wherein the server is further configured to learn from a plurality of images of the surface of the table in advance by using an unsupervised learning algorithm.

6. The system of claim 5, wherein the plurality of images are images of the table in a state in which no object is present on the table.

7. The system of claim 1, wherein the server is further configured to detect a presence or an absence of the falling object based on a learning value output by an unsupervised learning algorithm.

8. The system of claim 1, wherein the at least one image includes a first image of a first area of the surface of the table and a second image of a second area of the surface of the table.

9. The system of claim 8, wherein the camera unit includes a first camera configured to obtain the first image, and a second camera configured to obtain the second image.

10. The system of claim 1, wherein the server is further configured to output information on a presence of the falling object to a user based on a result value generated in the detect of the server.

11. A server comprising:
a memory;
a processor configured to perform an operation according to an instruction stored in the memory; and
a data transceiver configured to receive at least one image of a surface of a table from a camera unit,
wherein the processor is further configured to detect, from the at least one image, a first state in which an object is on the surface of the table or a second state in which no object is on the surface of the table, obtain information, when the first state is detected, on a first time during which the first state continues, detect that a falling object is on the surface of the table when the first time is more than a first reference time, and detect that no falling object is on the surface of the table when the first time is the first reference time or less,
wherein the first reference time is a cycle time during which a robot device repeatedly performs certain operations.

12. The server of claim 11, wherein the first reference time is a time during which the robot device performs a first operation of placing a substrate on the table, a second operation of waiting for a predetermined time, and a third operation of moving the substrate to a different position on the table.

13. The server of claim 11, wherein the processor is further configured to obtain information, when the second state is detected, on a second time, during which the second state continues.

14. The server of claim 13, wherein the processor is further configured to detect that a process stop state in which the robot device is not in operation has occurred when the second time is more than a second reference time.

15. The server of claim 11, wherein the processor is further configured to learn from a plurality of images of the surface of the table in advance by using an unsupervised learning algorithm.

16. The server of claim 15, wherein the plurality of images are images of the table in a state in which no object is on the table.

17. The server of claim 11, wherein the processor is further configured to detect a presence or an absence of the falling object based on a learning value output by an unsupervised learning algorithm.

18. The server of claim 11, wherein the at least one image includes a first image of a first area of the surface of the table and a second image of a second area of the surface of the table.

19. The server of claim 18, wherein the data transceiver is further configured to receive the first image from a first camera and receive the second image from a second camera.

20. The server of claim 11, wherein the processor is further configured to generate information on a presence of the falling object based on a result value generated in the detect of the processor.
